(19) United States
(12) Patent Application Publication
(10) Pub. No.: US 2017/0019570 A1
(43) Pub. Date: Jan. 19, 2017

(54) SOLAR ROW ONSITE AUTOMATIC INSPECTION SYSTEM

(71) Applicant: Ecoppia Scientific Ltd., Herzliya (IL)

(72) Inventors: Moshe Meller, Tel Aviv (IL); Eran Meller, Tel Aviv (IL)

(21) Appl. No.: 14/797,340

(22) Filed: Jul. 13, 2015

(51) Int. Cl. H04N 5/225; H04N 5/232; H04N 5/33; G06K 9/62; G01R 31/40; G06T 7/00

(52) U.S. Cl. CPC H04N 5/2252; H02S 50/00; G06T 7/001; H04N 5/33; G06T 7/004; G06K 9/6201; H04N 5/23296; G06T 2207/10048; G06T 2207/30108

(57) ABSTRACT

An inspection system for inspecting a solar row having a plurality of solar panels, the inspection system includes a moveable support construction, an imaging device and a controller, the imaging device being mounted on the moveable support construction, the controller being coupled with the moveable support construction and with the imaging device, the controller being configured to cause the moveable support construction to move the imaging device over the surface of the solar row and to cause the imaging device to image a selected target area of the solar row, the controller being further configured to analyze images acquired by the imaging device for detecting defects of the solar row.

### FIELD OF THE DISCLOSED TECHNIQUE

The disclosed technique relates to inspection of solar panels, solar rows and solar fields, in general, and to systems and methods for automatic onsite inspection, in particular.

### BACKGROUND OF THE DISCLOSED TECHNIQUE

The challenges of global climate change and energy security demands have made the development of renewable energy alternatives vital for the future of mankind. The use of direct sun radiation on solar panels can potentially produce more than enough energy to meet the energy needs of the entire planet. As the price of solar power decreases and that of conventional fuels rises, the solar business has entered a new era of worldwide growth.

Solar systems performance may be degraded due to various defects and damages, such as micro-cracks, broken cells, faulty interconnections or joints, and the like. Such defects can be produced during manufacturing of the cells and rows, transportation of the cells to the solar field site, installation of the cells and rows, or during operation of the solar field. Faulty panels or rows should be amended or replaced, for improving overall performance, and safety of the solar system. Therefore, detection of such defects and damages is important for maintaining the normal operation of the solar system.

Removing the panels and sending them to inspection at an inspection time is both time consuming and expensive. The removed panels are obviously not employed during the inspection (and the transportation time). Additionally, the transportation to and from the solar field site, and the removal and re-installation of the panels and rows may produce defects and damages to the solar panels and rows.

Onsite inspections, as known in the art, are performed manually. An expert arrives at the solar field site and inspects the panels and rows using inspection equipment. The expert may send data (e.g., images of the panels) to an inspection site for further analysis. Manual inspection are time consuming, and expensive (e.g., due to the required manual labor). Additionally, manual inspection usually means that the frequency of inspections is low (e.g., a solar field is inspected once a year).

Inspection methods include visual inspection, and Electroluminescence (EL) inspection. For visual inspection, the panels and rows can be imaged and the images are analyzed. For EL inspection, A current is applied to the solar panel and a NIR-image of the panel is recorded. The EL inspection is performed after twilight or in the night.

### SUMMARY OF THE DISCLOSED TECHNIQUE

In accordance with an embodiment of the disclosed technique, there is thus provided an inspection system for inspecting a solar row having a plurality of solar panels. The inspection system includes a moveable support construction, an imaging device, and a controller. The imaging device is mounted on the moveable support construction. The controller is coupled with the moveable support construction and with the imaging device. The moveable support construction is configured to selectively move over a surface of the solar row. The imaging device is selectively operable to image a selected target area of the solar row. The controller is configured to cause the moveable support construction to move the imaging device over the surface of the solar row and to cause the imaging device to image the selected target area of the solar row. The controller is further configured to analyze images acquired by the imaging device for detecting defects of the solar row.

In accordance with another embodiment of the disclosed technique, there is thus provided an inspection method for inspecting a solar row having a plurality of solar panels. The inspection method includes the steps of moving a moveable support construction having an imaging device mounted thereon to a target area of the solar row, imaging the target area of the solar row by the imaging device, and analyzing the images of the solar row for detecting defects of the solar row.

### BRIEF DESCRIPTION OF THE DRAWINGS

The disclosed technique will be understood and appreciated more fully from the following detailed description taken in conjunction with the drawings in which:

FIG. 1 is a schematic illustration of an inspection system, constructed and operative in accordance with an embodiment of the disclosed technique;

FIG. 2 is a schematic illustration of a block diagram of an inspection system, constructed and operative in accordance with another embodiment of the disclosed technique;

FIG. 3 is a schematic illustration of an inspection method, operative in accordance with a further embodiment of the disclosed technique; and

FIG. 4 is a schematic illustration of an inspection system, constructed and operative in accordance with yet another embodiment of the disclosed technique.

### DETAILED DESCRIPTION OF THE EMBODIMENTS

The disclosed technique overcomes the disadvantages of the prior art by providing an inspection system and method for onsite automatic inspection of solar panels, solar rows and solar fields. The inspection system includes a moveable support construction, an imaging device and a controller. The imaging device is mounted on the moveable support construction. The controller is coupled with the imaging device and with the moveable support construction. The support construction can move over the surface of the solar row, for example moving in both the width direction and the length direction of the solar row (or panel). The imaging device images a selected target area of the solar row. The controller analyzes the acquired images for detecting defects on the solar row (or panel).

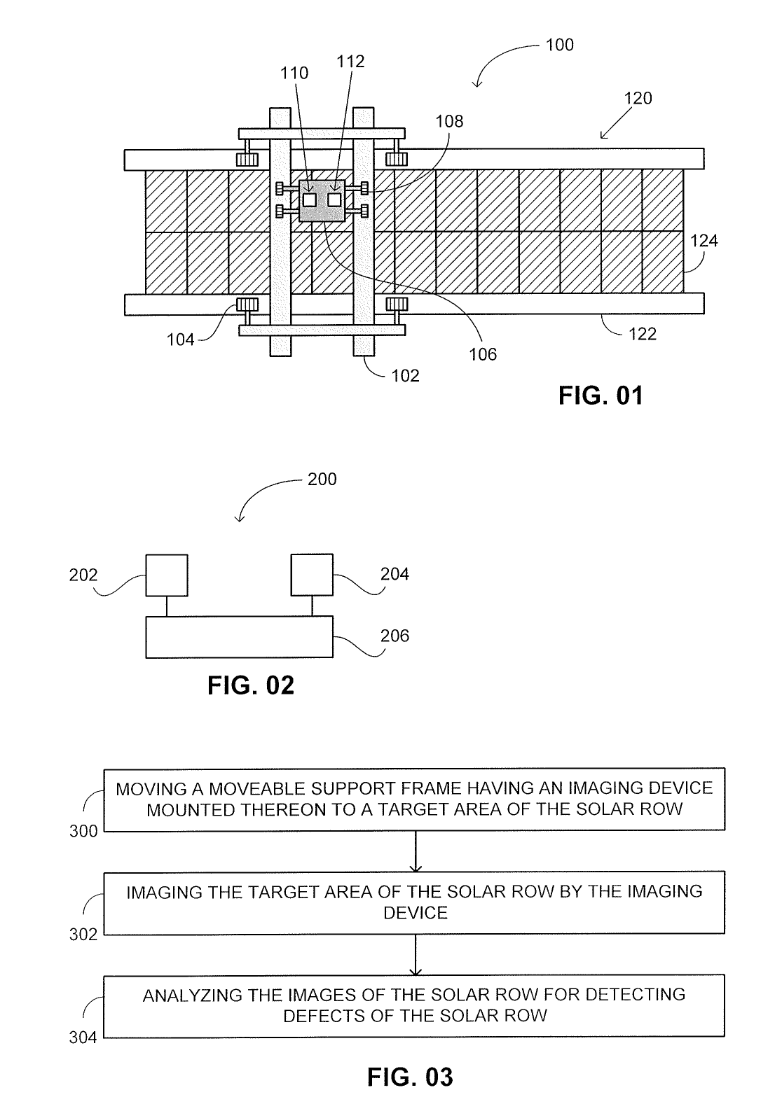

Reference is now made to FIG. 1, which is a schematic illustration of an inspection system, referenced 100, constructed and operative in accordance with an embodiment of the disclosed technique. Inspection system 100 includes a main frame 102, a secondary frame 106, and cameras 110 and 112. Main frame 102 is moveably mounted on a pair of rails 122 of a solar row 120, such that main frame 102 can slide across the length of solar row 120 (left-right in FIG. 1). Secondary frame 106 is moveably mounted on main frame 102, such that secondary frame 106 can slide across the width of solar row 120 (up-down in FIG. 1). Cameras 110 and 112 are mounted on secondary frame 106. Inspection system 100 further includes a controller (not shown) for controlling the operation of main frame 102, secondary frame 106, and cameras 110 and 112. The controller can be mounted on secondary frame 106, main frame 102, another place on solar row 120, or off solar row 120 (e.g., at a control site within the solar field, or at remote location).

Inspection system 100 is shown in combination with a row of solar panel assemblies 120 (solar row 120). Solar row 120 includes a plurality of solar panels 124 mounted on a pair of parallel rails 122. Rails 122 may be made from steel, fiberglass or other metallic or non-metallic materials. Solar panels 124 can be of any type and construction known to those skilled in the art. For example, a single solar panel may have a face area less than about one square meter. A length of solar row 120 can vary between about a few meters to about a few kilometers. A width of solar row 120 ranges from about one meter to about several meters. Solar row 120 may be constructed in an angular or inclined position toward the sun, which creates a lower edge and a higher edge of solar row 120. Alternatively, the solar row may be mounted on a sun tracking system.

Main frame 102 and secondary frame 106 form, together, a moveable support construction (not referenced) that enables bi-directional movement of cameras 110 and 112. This bi-directional movement enables cameras 110 and 112 to move along solar row 120 in two directions—along the length of solar row 120 and in the width direction of solar row 120. Main frame 102 is movable along the length of solar row 120. Main frame 102 can be made from aluminum constructive profiles, steel, fiberglass or other materials. Main frame 102 includes an actuating mechanism (not shown), including a set of wheels 104, a motor (not shown), and additional elements required for moving it along rails 122 as known in the art (e.g., gears, chains and the like). Alternatively, other actuating mechanisms can be employed for moving main frame 102 along rails 122, having different number of wheels, motors, or having different components such as arms or legs for moving main frame 102. Secondary frame 106 is movable along main frame 102.

Secondary frame is made of similar materials, and includes similar actuating mechanism as described herein above with respect to main frame 102. For example, secondary frame includes a set of wheels 108, and a motor (not shown).

In accordance with alternative embodiments, other moveable frames that enable moving cameras 110 and 112 over solar row 120 are contemplated to be within the scope of the invention. For example, the moveable frame can employ a robotic arm mounted on a sliding platform. In accordance with yet another embodiment, the cameras can be mounted on a moveable support construction of another robotic system, such as a cleaning system for cleaning the surface of the solar panels. Thus, a moveable support construction carries various systems having various functionalities (e.g., inspection, cleaning, or other control and maintenance operations).

In accordance with another embodiment of the disclosed technique, the moveable support construction includes encoders, or other motion or position detection devices, for monitoring the movement or the position of main frame 102 and of secondary frame 104. The encoders allow inspection system 100 to monitor the position of main frame 102 and of secondary frame 106, and thereby to monitor the position of cameras 110 and 112 over solar row 120. Thereby, inspection system determines the position of defects detected on the solar row. Exemplary position or motion monitoring devices are accelerometers, magnetic positioning devices, ultrasonic positioning devices, and optic positioning devices. In accordance with an alternative embodiment, the position of the moveable support construction, or the position of the defects is determined from the images acquired by the cameras. For example, fiducials, or other marks that can be captured in the acquired images, are added to the solar row, so that the position of the camera can be determined from the fiducials in the image.

Inspection system 100 may further include a power source (not shown). For example, the power source includes one or more batteries that may be rechargeable, replaceable, and the like. The power source may itself include a set of solar panels (not shown) attached to the moveable support construction. Thereby inspection system 100 can operate independently without connection to any other source of electricity.

Cameras 110 and 112 acquire images of solar row 120, for inspecting solar row 120. Each of cameras 110 and 112 acquires an image of a respective target area, and the cameras can be moved to scan the entire solar row. In accordance with an embodiment of the disclosed technique, camera 110 is a visible light camera, and camera 112 is an infrared camera. The acquired images are sent to the controller which inspects the images and locates defects of solar row 120. In accordance with an alternative embodiment, the images can be sent to a remote inspection processor located off the solar row (e.g., at an inspection site within the solar field, or at a remote inspection site). The image analysis would be detailed further herein below with reference to FIG. 2.

Reference is now made to FIG. 2, which is a schematic illustration of a block diagram of an inspection system, generally referenced 200, constructed and operative in accordance with another embodiment of the disclosed technique. Inspection system 200 includes a first imaging device 202, a second imaging device 204, and a controller 206. Controller 206 is coupled with each of first imaging device 202 and second imaging device 204 (either connected via wires, or wirelessly coupled). The imaging devices are mounted on a moveable support construction allowing inspection system 200 to move the imaging devices over a solar row to be inspected. Controller 206 can be mounted on the moveable support construction as well, mounted on the solar row, or located remotely from the solar row.

First imaging device 202 is a visible light camera. First imaging device 202 selectively acquires images of a respective target area of the solar row. By moving the first imaging device over the solar row, the entire solar row can be scanned and inspected. First imaging device 202 can be complemented with an illumination device for illuminating the target area. The acquired images are transmitted to controller 206 for analysis.

Controller 206 inspects the visible images of the target area of the solar row for locating defects, such as cracked, bent, misaligned or torn external surfaces; broken cells; cracked cells; faulty interconnections or joints; cells touching one another or the frame; failure of adhesive bonds; bubbles or delaminations forming a continuous path between a cell and the edge of the cell assembly or the solar row; tacky surface of plastic materials; faulty terminations, or exposed live electrical parts; any other conditions which may affect performance of the solar cell or the solar row.

Second imaging device 204 is an infrared camera. Second imaging device 204 selectively acquires images of a respective target area of the solar row. By moving the second imaging device over the solar row, the entire solar row can be scanned and inspected. Second imaging device 204 can be employed for electroluminescence (EL) inspection of the solar cells of the solar row. In this case, a current (e.g., the short circuit current—I_{sc}—of the cell, or a lower current) is applied to a selected solar cell, and an infrared image of that cell is recorded by second imaging device 204. It is noted that EL inspection of the solar cells is performed in darkness, for example during the night time. Alternatively, second imaging device 204 can further be complimented with a light blocking element for darkening the target area (e.g., a curtain).

Additionally, second imaging device can be employed for acquiring infrared images of the solar row, and can be complemented with an infrared illumination source. The acquired images are transmitted to controller 206 for analysis.

Controller 206 inspects the infrared images of the target area of the solar row for locating defects, such as micro-cracks; broken cells; finger interruptions; band-conveyor pattern (e.g., may be caused by inhomogeneous temperatures on the cell during firing of the grid-fingers); impurities; and other conditions which may affect the performance of the solar cell or the solar row.

Controller 206 receives the images acquired by first and second imaging devices 202 and 204, and analyzes the images for detecting and locating defects of the solar cells, or the solar rows. Controller 206 further determines the position of the detected defects. For example, controller 206 determines the position of the moveable support construction at the time a selected image was acquired (e.g., by employing encoders), and accordingly determines the position of the defect detected in that image. In accordance with another example, controller 206 determines the position of the defect from the image itself, by identifying landmarks in the image, such as dedicated fiducials or other landmarks.

Controller 206 can further receive additional data for detecting defects, such as the output of a selected cell, or of the solar row, and data gathered by additional sensors. For example, the inspection system can include other or additional sensors, such as imaging devices of other spectrum ranges of electromagnetic radiation; other imaging modalities, such as ultrasonic imaging; and any other sensors which can detect defects in a solar cell, or the solar row. The other sensors can be mounted on the moveable support construction, on another moveable support construction, on the solar row, or off the solar row. For example, the additional sensors can be employed for acquiring images of the bottom of the solar row, the sides of the solar row, or other perspectives of the solar row.

Controller 206 stores the acquired images and the analyzed data in a data storage device (not shown). Controller 206 can employ the stored data for locating defects. For example, an image of a selected target area can be compared to previously acquired images, for determining differences between the images, which may indicate a defect. Controller 206 alerts a user about located defects, and the progression of defects (e.g., a micro-crack in a cell which is getting bigger over time).

In accordance with an alternative embodiment, controller 206 only controls the movements of the moveable support construction, and the operation of the imaging devices. In this case, the analysis of the images is performed by an inspection processor located at a central control site in the solar field, or at a remote location. Controller 206 provides the acquired images, and data associated with each image (e.g., the timestamp and the position of the target area within the solar row) to the control site.

Reference is now made to FIG. 3, which is a schematic illustration of an inspection method, operative in accordance with a further embodiment of the disclosed technique. In procedure 300, a moveable support construction, having an imaging device mounted thereon, is moved to a target area of the solar row. The moveable support construction allows the imaging device to sequentially scan the entire solar row. The moveable support construction can include additional imaging devices, and other or additional sensors, such as ultrasonic sensors, magnetic sensors, and any other sensor which can be employed for detecting defects of the solar row. With reference to FIG. 1, the moveable support construction, having first and second cameras 110 and 112 mounted thereon (i.e., mounted on secondary frame 106), is moved to a target area of solar row 120.

In procedure 302, the target area of the solar row is imaged by the imaging device. The imaging device can be a visible light imaging device, an infrared imaging device, or a combination several imaging devices, each having different parameters (e.g., different image spectrums, different target area size, different magnification, zoom, focus, and the like). The target area may be illuminated by an illumination source. The target area may be darkened (e.g., imaging during the night time, or by employing a light blocking component such as a curtain). A solar cell may be fed with current for acquiring electroluminescence images of the target area. With reference to FIG. 1, each of first camera 110 and second camera 112 acquires images of a respective target area.

In procedure 304, the images of the solar row are analyzed for detecting defects of the solar row. The acquired images are provided to a controller, or another inspection processor. The controller analyzes the images and detects defects of the solar row. The controller can compare the images to previously acquired images, for determining differences between the images, which might provide indications of defects. The controller can further receive additional data for detecting the defects, such as the output of the solar cells and of the solar row. The controller can employ additional sensors for detecting the defects, such as other or additional imaging devices, and other sensors. The position of each defect on the solar row is also determined. The defect position can be determined according to the position of the imaging device when acquiring the image according to which the defect is detected. The defect position can also be determined from the image itself, for example, by identifying known landmarks within the image. With reference to FIG. 2, controller 206 analyzes the acquired images, and detects and locates defects of the solar row.

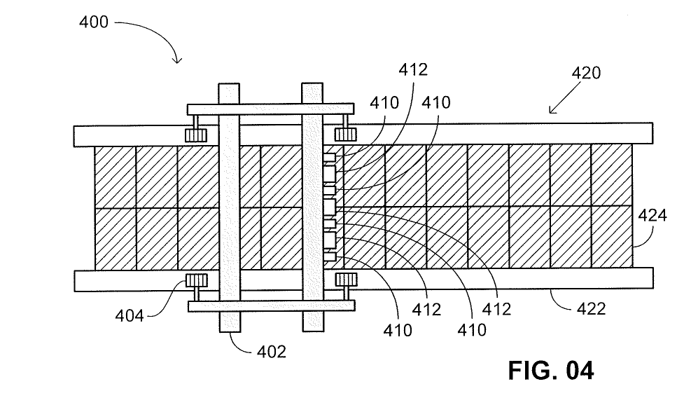

Reference is now made to FIG. 4, which is a schematic illustration of an inspection system, referenced 400, constructed and operative in accordance with yet another embodiment of the disclosed technique. Inspection system 400 includes a moveable support construction 402, a set of visible light cameras 410 and a set of infrared cameras 412. Moveable support construction 402 is moveably mounted on a pair of rails 422 of a solar row 420, such that moveable support construction 402 can slide across the length of solar row 420 (left-right in FIG. 4).

Cameras 410 are arranged across the length of moveable support construction 402, such that the field of view of cameras 410 together covers the width of solar row (up-down in FIG. 4). In a similar manner, Cameras 412 are arranged across the length of moveable support construction 402, such that the field of view of cameras 412 together covers the width of solar row.

Inspection system 400 further includes a controller for controlling the operation thereof, and can further include any other element mentioned herein above with reference to FIGS. 1 and 2 (e.g., encoders, an actuating mechanism, and a power source). The operation of inspection system 400 is substantially similar to that of inspection system 100 of FIG. 1. The difference being that moveable support construction 402 only moves along a single axis of the solar row (i.e., along the length of the solar row). For allowing for full coverage of the other axis of the solar row (i.e., of the width of the solar row), a plurality of cameras are employed. The combined field of view of the cameras fully covers the width of the solar row.

In accordance with an alternative embodiment of the disclosed technique, the cameras can be rotated for covering a larger surface area of the solar row. Thereby, the number of cameras can be decreased, while still fully covering the surface of the solar row. In accordance with other alternative embodiments of the disclosed technique, the moveable support construction moves in different paths, or patterns, and there are different sets of cameras arranged in various configurations for covering the surface of the solar row.

It will be appreciated by persons skilled in the art that the disclosed technique is not limited to what has been particularly shown and described hereinabove. Rather the scope of the disclosed technique is defined only by the claims, which follow. Additionally, some aspects of the disclosed technique are hereinabove described with reference to a particular embodiment, however, every aspect and feature of the disclosed technique can be employed in other embodiments of the disclosed technique, and such combinations are not disclosed for the sake of brevity.

1. An inspection system for inspecting a solar row having a plurality of solar panels and a pair of parallel rails, said solar row having a length and a width, said pair of parallel rails being coupled with said plurality of solar panels, the inspection system comprising:
a moveable support frame being configured to selectively move over a surface of said solar row over said pair of parallel rails in a single axis parallel to said pair of parallel rails, said single axis being in said length of said solar row, said moveable support frame comprising a secondary frame being configured to selectively move over a width of said solar row, said width being a single axis perpendicular to said pair of parallel rails;
at least two imaging devices mounted on said secondary frame, said at least two imaging devices being selectively operable to image a selected target area of said solar row; and
a controller coupled with said moveable support frame and with said at least two imaging devices, said controller being configured to cause said moveable support frame and said secondary frame to move said at least two imaging devices simultaneously over said surface of said solar row and to cause said at least two imaging devices to image said selected target area of said solar row, said controller is further configured to analyze images acquired by said at least two imaging devices for detecting defects of said solar row,
wherein a first one of said at least two imaging devices is a visible light camera and a second one of said at least two imaging devices is an infrared camera thereby enabling a more efficient inspection of said solar row by detecting defects visible over a spectrum comprising visible light and infrared light.

2. (canceled)

3. The system according to claim 1, wherein said defects detected by said controller according to said visible light image comprises at least one defect selected from the list consisting of:
cracked, bent, misaligned or torn external surfaces;
broken cells;
cracked cells;
faulty interconnections or joints;
cells touching one another or said frame;
failure of adhesive bonds;
bubbles or delaminations forming a continuous path between a cell and an edge of said cell assembly or said solar row; and
tacky surface of plastic materials, faulty terminations, or exposed live electrical parts.

4. (canceled)

5. The system according to claim 1, wherein said infrared camera images an electroluminescence image of a solar cell when a current is fed into said solar cell.

6. The system according to claim 5, wherein said defects detected by said controller according to an electroluminescence image comprise at least one defect selected from the list consisting of:
micro cracks;
broken cells;
finger interruptions;
band-conveyor pattern; and
impurities.

7. The system according to claim 1, further comprising a position detector for determining a position of said at least two imaging devices, and wherein said controller is further configured to determine a position of a detected defect on said solar row.

8. The system according to claim 1, wherein a cleaning apparatus for cleaning said solar panels is also mounted on said moveable support frame.

9. The system according to claim 1, wherein said moveable support frame is moveable in both a width direction and a length direction of said solar row.

10. The system according to claim 1, wherein said moveable support frame is moveable along a length of said solar row, and wherein said system further comprises additional imaging devices mounted on said moveable support frame, such that a combined field of view of said imaging devices covers together a width of said solar row.

11. An inspection method for inspecting a solar row having a plurality of solar panels and a pair of parallel rails, said solar row having a length and a width, said pair of parallel rails being coupled with said plurality of solar panels, the inspection method comprising the steps of:
moving a moveable support frame having at least two imaging devices mounted over said pair of parallel rails in a single axis parallel to said pair of rails thereon to a target area of said solar row, said single axis being in said length of said solar row, said moveable support frame comprising a secondary frame being configured to selectively move over a width of said solar row, said width being a single axis perpendicular to said pair of parallel rails;
simultaneously imaging said target area of said solar row by said at least two imaging devices; and
analyzing said images of said solar row for detecting defects of said solar row,
wherein a first image taken by a first one of said at least two imaging devices is a visible light image and a second image taken by a second one of said at least two imaging devices is an infrared electroluminescence image thereby enabling a more efficient inspection of said solar row by detecting defects visible over a spectrum comprising visible light and infrared light.

12. (canceled)

13. The inspection method according to claim 11, wherein said defects detected according to said visible light image comprises at least one defect selected from the list consisting of:
cracked, bent, misaligned or torn external surfaces;
broken cells;
cracked cells;
faulty interconnections or joints;
cells touching one another or a frame;
failure of adhesive bonds;
bubbles or delaminations forming a continuous path between a cell and an edge of said cell assembly or said solar row; and
tacky surface of plastic materials, faulty terminations, or exposed live electrical parts.

14. The inspection method according to claim 11, wherein said electroluminescence image of said target area of a solar cell is being acquired when a current is fed into said solar cell.

15. The inspection method according to claim 14, wherein said defects detected according to said electroluminescence image comprises at least one defect selected from the list consisting of:
micro cracks;
broken cells;
finger interruptions;
band-conveyor pattern; and
impurities.

16. The inspection method according to claim 11, wherein said step of analyzing said images comprises comparing said images to previously acquired images.

17. The inspection method according to claim 11, further comprising determining a position of a detected defect on said solar row.

18. The system according to claim 7, wherein said controller determines said position of said detected defect on said solar row in a simplified way due to said moveable support frame moving over said solar row in said single axis parallel to said pair of parallel rails and said secondary frame moving over said single axis perpendicular to said pair of parallel rails.

19. The inspection method according to claim 17, wherein determining said position of said detected defect on said solar row is simplified due to said moveable support frame moving over said solar row in said single axis parallel to said pair of parallel rails and said secondary frame moving over said single axis perpendicular to said pair of parallel rails.
